(19) United States
(12) Patent Application Publication
(10) Pub. No.: US 2024/0297712 A1
(43) Pub. Date: Sep. 5, 2024

(54) Environmental Change Detection

(71) Applicant: NPL Management Limited, Teddington (GB)

(72) Inventor: Giuseppe Marra, London (GB)

(21) Appl. No.: 18/634,001

(22) Filed: Apr. 12, 2024

Related U.S. Application Data
(63) Continuation of application No. PCT/GB2022/052592, filed on Oct. 12, 2022.

(30) Foreign Application Priority Data
Oct. 13, 2021 (GB) 2114633.7

(51) Int. Cl. H04B 10/071; H04B 10/25; H04B 10/291

(52) U.S. Cl. CPC H04B 10/071; H04B 10/25; H04B 10/2912

(57) ABSTRACT

A method of dynamic change detection using an optical fibre arrangement in disclosed. The optical fibre arrangement can include a forward optical path and a second optical path. The optical fibre arrangement can be configured into a plurality of spans by a plurality of nodes between first and second ends of the optical fibre arrangement. At least one of the nodes includes a feed from the forward path to the second path such that forward propagation of the light signal from the forward path feeds the second path. The method can include transmitting a light signal into the forward path; receiving a response signal from the second path, wherein the response signal includes a loop back signal that includes a light signal fed into the second path via the feed; and detecting dynamic changes along a span associated with the feed from the loop back signal.

### CROSS-REFERENCE TO RELATED APPLICATIONS

This application is a continuation of and claims priority benefits from International Application No. PCT/GB2022/052592 filed on Oct. 12, 2022, entitled, “Environmental Change Detection” which, in turn, is related to and claims priority benefits from GB patent application 2114633.7 filed on Oct. 13, 2021.

This application also claims priority benefits from the 2114633.7 application. The '592 and '633.7 applications are each hereby incorporated by reference herein in their entireties.

### FIELD OF THE INVENTION

The present invention relates to dynamic change detection using an optical fibre arrangement, which in embodiments can be used for dynamic environmental change detection.

Submarine cables (varying in length, including short cables of for example 100 km and long cables 1000s of km long), in the form of optical fibres, exist throughout the world for telecommunications. Optical fibres are sensitive to temperature, pressure, strain, humidity. Parameters of the light travelling through the fibre (like optical phase or polarization) change when any of these parameters change. Accordingly, these cables can be used to perform environmental sensing.

In some techniques, phase or polarization-based seismic detection techniques provide a signal that is integrated over the entire length of the submarine cable (can for example be 5,000 to 7,000 km or even longer in the case of inter-continental links).

In other techniques, environmental sensing with high spatial resolution can be achieved using Distributed Acoustic Sensing (DAS). In this case the light reflected by inhomogeneities in the fibre is analysed. A pulse is sent and the information is extracted by analysing the returned signal at different times, corresponding to different distances along the fibre. Whilst this technique can be effective, because of the low level of the returned signal it is limited to sensing the first tens of km of a cable.

U.S. Pat. No. 10,979,140 B2 provides apparatuses to detect occurrence and location of damages on optical fibre links in advance by converting an optical span in optical network to an interferometry based sensing media. The interferometry based sensing media may enable detection of mechanical perturbation or mechanical vibration occurred on optical fibre links across optical network.

Aspects of the present invention seek to provide an improved method and system for detecting dynamic changes using an optical fibre arrangement.

### SUMMARY OF THE INVENTION

According to an aspect of the invention, there is provided a method of dynamic change detection using an optical fibre arrangement, the optical fibre arrangement comprising a forward optical path and a second optical path, the optical fibre arrangement being configured into a plurality of spans by a plurality of nodes, the plurality of nodes being between first and second ends of the optical fibre arrangement, a first span having a first node at a first end and a second node at a second end, each of the first and second nodes including a feed from the forward path to the second path such that forward propagation of the light signal from the forward path feeds the second path, the method including:
transmitting a light signal into the forward path;
receiving a response signal from the second path, wherein the response signal comprises a first loop back signal and a second loop back signal, the first loop back signal comprising light signal fed into the second path via the feed of the first node, the second loop back signal comprising light signal fed into the second path via the feed of the second node;
obtaining from the response signal first and second signal elements relating to, respectively, the first and second loop back signals;
detecting dynamic changes along the first span from dynamic changes in a difference between the first signal element and the second signal element.

It will be appreciated that the term ‘first span’ is not intended to indicate the position of the span along the optical fibre.

In some embodiments, dynamic changes along the first span are detected from phase changes and/or frequency changes in the first and/or second signal elements.

In some embodiments, the frequency of the light signal is swept such that the light signal includes at least one frequency sweep, wherein optionally the first and second signal elements are obtained based on frequency of the loop back signals.

In some embodiments, each of the at least one frequency sweep has a continuously varying frequency.

In some embodiments, the first and second signal elements are the first and second loop back signals respectively.

In some embodiments, the first signal element is a first loop back beat signal formed from the first loop back signal and a reference signal; wherein the second signal element is a second loop back beat signal formed from the second loop back signal and the reference signal.

In some embodiments, the reference signal includes the light signal.

In some embodiments, the method includes detecting vibrations, temperature, humidity and pressure perturbations along the first span.

In some embodiments, the method includes performing dynamic environmental change detection for the first span from the detected dynamic changes.

In some embodiments, the method includes performing seismic detection, for example detection of earthquakes.

In some embodiments, detecting dynamic changes along the first span includes using Optical Frequency Domain Reflectometry (OFDR).

In some embodiments, a plurality of the spans are each configured as recited for the first span and result in the response signal comprising respective loop back signals for each span as recited for the first span, the steps for detecting dynamic changes along the respective span from the respective loop back signals being as recited for the first span.

According to an aspect of the invention, there is provided a system for detecting dynamic change, including:
a light transmitter configured to transmit a light signal into a forward path of an optical fibre arrangement, the optical fibre arrangement comprising a second path and being configured into a plurality of spans by a plurality of nodes, the plurality of nodes being between first and second ends of the optical fibre arrangement, a first span having a first node at a first end and a second node at a second end, each of the first and second nodes comprising a feed from the forward path to the second path configured to feed forward propagation of the light signal from the forward path into the second path;
a light processor configured to process a response signal received from the second path, the response signal comprising a loop back signal and a second loop back signal, the first loop back signal comprising light signal fed into the second path via the feed of the first node, the second loop back signal comprising light signal fed into the second path via the feed of the second node;
the light processor being configured to:
obtain from the response signal first and second signal elements relating to, respectively, the first and second loop back signals; detect dynamic changes along the first span from dynamic changes in a difference between the first signal element and the second signal element.

In some embodiments, the light transmitter is configured to sweep the frequency of the light signal such that the light signal includes at least one frequency sweep.

In some embodiments, the light processor is configured to perform dynamic environmental change detection for the first span from the detected dynamic changes along the first span.

In some embodiments, a plurality of the spans are each configured as recited for the first span and result in the response signal comprising respective loop back signals for each span as recited for the first span, the light processor being configured to perform the steps for detecting dynamic changes along the respective span from the respective loop back signals, as recited for the first span.

According to an aspect of the invention, there is provided a method of dynamic change detection using an optical fibre arrangement, the optical fibre arrangement comprising a forward optical path and a second optical path, the optical fibre arrangement being configured into a plurality of spans by a plurality of nodes, the plurality of nodes being between first and second ends of the optical fibre arrangement, each of the plurality of nodes including a feed from the forward path to the second path such that forward propagation of the light signal from the forward path feeds the second path at each of the plurality of nodes to loop back a corresponding loop back signal, each of the plurality of spans being associated with one or more of the feeds, the method including:
transmitting a light signal into the forward path, wherein the frequency of the light signal is swept such that the light signal includes at least one frequency sweep;
receiving a response signal from the second path, wherein the response signal comprises the loop back signals corresponding to each of the feeds;
obtaining signal elements relating to each of the loop back signals based on frequency of the loop back signals;
for each of the plurality of spans, detecting dynamic changes along the span from the signal element relating to the loop back signal corresponding to an associated feed.

In some embodiments, the method includes for each of the plurality of spans detecting dynamic changes along the span from dynamic changes in one or more of phase, frequency, intensity and polarisation, in the signal element relating to the loop back signal corresponding to the associated feed, preferably from dynamic changes in phase and/or frequency.

In some embodiments, each of the at least one frequency sweep has a continuously varying frequency.

In some embodiments, the signal elements are beat signals each formed from the respective loop back signal and a reference signal, the method including, for each of the plurality of spans, detecting dynamic changes along the span from dynamic changes in the beat signal formed from the loop back signal corresponding to an associated feed.

In some embodiments, the reference signal includes the light signal.

In some embodiments, dynamic changes in the beat signal are dynamic changes in one or more of: phase, frequency, intensity, and polarisation; preferably are dynamic changes in phase and/or frequency.

In some embodiments, for each of the plurality of spans, detecting dynamic changes along the span includes differentiating dynamic changes relating to a loop back signal corresponding to a first associated feed from dynamic changes relating to a loop back signal corresponding to a second associated feed.

In some embodiments, the method includes detecting vibrations, temperature, humidity and pressure perturbations along each of the plurality of spans.

In some embodiments, the method includes performing dynamic environmental change detection for each of the plurality of spans from the detected dynamic changes.

In some embodiments, the method includes performing seismic detection, for example detection of earthquakes.

In some embodiments, for each of the plurality of spans, detecting dynamic changes along the span includes using Optical Frequency Domain Reflectometry (OFDR).

According to an aspect of the invention, there is provided a system for detecting dynamic change, including:
a light transmitter configured to transmit a light signal into a forward path of an optical fibre arrangement, the optical fibre arrangement comprising a second path and being configured into a plurality of spans by a plurality of nodes, the plurality of nodes being between first and second ends of the optical fibre arrangement, each of the plurality of nodes comprising a feed from the forward path to the second path configured to feed forward propagation of the light signal from the forward path into the second path to loop back a corresponding loop back signal, each of the plurality of spans being associated with one or more of the feeds;
a light processor configured to process a response signal received from the second path, the response signal comprising the loop back signals corresponding to each of the feeds;
the light processor being configured to:
obtain signal elements relating to each of the loop back signals based on frequency of the loop back signals;
for each of the plurality of spans, detect dynamic changes along the span from the signal element relating to the loop back signal corresponding to an associated feed;
wherein the light transmitter is configured to sweep the frequency of the light signal such that the light signal includes at least one frequency sweep.

In some embodiments, the light processor is configured to perform dynamic environmental change detection for each of the plurality of spans from the detected dynamic changes along the respective span.

According to an aspect of the invention, there is provided a method of dynamic change detection using an optical fibre arrangement, the optical fibre arrangement comprising a forward optical path and a second optical path, the optical fibre arrangement being configured into a plurality of spans by a plurality of nodes, the plurality of nodes being between first and second ends of the optical fibre arrangement, at least one of the nodes including a feed from the forward path to the second path such that forward propagation of the light signal from the forward path feeds the second path, the method including:
transmitting a light signal into the forward path;
receiving a response signal from the second path, wherein the response signal comprises a loop back signal, the loop back signal comprising light signal fed into the second path via the feed;
detecting dynamic changes along a span associated with the feed from the loop back signal.

In some embodiments, detecting dynamic changes along the span associated with the feed from the loop back signal includes detecting dynamic changes along the span associated with the feed from dynamic changes in the loop back signal.

In some embodiments, each node includes a feed from the forward path to the second path such that forward propagation from the forward path feeds the second path at each of the plurality of nodes to loop back a corresponding loop back signal, the response signal comprises the loop back signals corresponding to each of the feeds, and each span is associated with one or more of the feeds, the method including:
for at least one span detecting dynamic changes along the span from the loop back signal corresponding to one or more associated feeds.

In some embodiments, for each of the at least one span, detecting dynamic changes along the span from the loop back signal corresponding to one or more associated feeds includes detecting dynamic changes along the span from dynamic changes in the loop back signal corresponding to one or more associated feeds.

In some embodiments, for each span the one or more associated feeds is/are one or more adjacent feeds.

In embodiments, the forward path is in a first direction, the second path is in a second direction opposite to the first direction, and forward propagation from the forward path feeding the second path means that the node, specifically the feed, is configured to transfer at least a portion of the light signal travelling on the forward path in the first direction to the second path in the second direction to provide the corresponding loop back signal.

Embodiments of the present invention provide advantages in that they can provide localised dynamic change detection all the way along the length of a cable.

By using specific feeds rather than reflections, embodiments of the invention can return a strong signal that can be used to perform sensing along a greater distance of the cable than conventionally achieved with DAS. This can be used to detect changes at a single location, at multiple locations, and/or across the whole fibre arrangement with spatial resolution. This could be used to detect and locate dynamic environmental changes such as earthquakes, tsunamis etc.

When used with the forward propagation loop back feed, or HLLB path, which is already present in many submarine cables, embodiments of the invention can exploit the repeater nodes for spatial resolution. Because the HLLB path is already present, this can be done without requiring additional components to be added to the difficult-to-access spans and repeaters of the submarine cable.

In embodiments, the or each loop back signal relates to dynamic changes along the optical fibre arrangement traversed by the light signal and the loop back signal up to and back from the respective feed/node. This is because the optical path to the respective feed/node traversed by that portion of the light signal which forms the loop back signal, and then by the loop back signal on its return, will have been affected by any such dynamic changes.

In some embodiments, detecting dynamic changes along a span includes detecting dynamic changes to light propagation through the entire length of the span.

In some embodiments, each node is between adjacent spans.

In some embodiments, there can be multiple instances of the light signal, resulting in multiple instances of the loop back signal(s). It is to be noted that dynamic changes in the or each loop back signal can include dynamic changes between different instances of the or each loop back signal, for example resulting from different instances of the light signal, and/or can include dynamic changes occurring within a single instance of the or each loop back signal.

Of course, it is to be noted that any changes in the light signal transmitted are not to be considered dynamic changes in the loop back signal(s).

In some embodiments, the method includes obtaining signal elements relating to each of the loop back signals based on frequency of the loop back signals and for each of the at least one span detecting dynamic changes along the span from the signal element relating to the loop back signal corresponding to the one or more associated feeds.

In some embodiments, the method includes distinguishing the loop back signals based on time of receipt of the loop back signals at a light processor at an end of the second path.

In some embodiments, dynamic changes in the loop back signal or signals include dynamic changes as compared to the light signal and/or include only dynamic changes as a result of changes in propagation in the forward and second paths.

In some embodiments, detecting dynamic changes along the or each of the at least one span from dynamic changes in the loop back signal or signals includes detecting dynamic changes along the respective span from dynamic changes in an internal feature of the respective loop back signal or signals.

In some embodiments, the internal feature is selected from the group consisting of: frequency, polarisation, wavelength, phase, intensity.

In some embodiments, the method includes sweeping the frequency of the light signal such that the light signal has a continuously varying frequency sweep and/or such that the light signal includes at least one frequency sweep, each of the at least one frequency sweep preferably having a continuously varying frequency.

In some embodiments, the method includes, for the or each of the at least one span, detecting dynamic changes along the span from dynamic changes in a beat signal formed from the loop back signal corresponding to an associated feed and a reference signal.

In some embodiments, the reference signal includes the light signal.

In some embodiments, dynamic changes in the beat signal are dynamic changes in one or more of: phase, frequency, wavelength, intensity, polarisation.

In some embodiments, for the or each of the at least one span, detecting dynamic changes along the span includes differentiating dynamic changes relating to a loop back signal corresponding to a first associated feed from dynamic changes relating to a loop back signal corresponding to a second associated feed.

In some embodiments, the method includes detecting vibrations, temperature, humidity and pressure perturbations along the or each of the at least one span.

In some embodiments, the method includes performing dynamic environmental change detection for the or each of the at least one span from the detected dynamic changes.

In some embodiments, the method includes performing seismic detection, for example detection of earthquakes.

In some embodiments, for the or each of the at least one span, detecting dynamic changes along the span includes using Optical Frequency Domain Reflectometry (OFDR).

According to an aspect of the invention, there is provided a system for detecting dynamic change, including:
a light transmitter configured to transmit a light signal into a forward path of an optical fibre arrangement, the optical fibre arrangement comprising a second path and being configured into a plurality of spans by a plurality of nodes, the plurality of nodes being between first and second ends of the optical fibre arrangement, and at least one of the nodes comprising a feed from the forward path to the second path configured to feed forward propagation of the light signal from the forward path into the second path;
a light processor configured to process a response signal received from the second path, the response signal comprising a loop back signal, the loop back signal comprising light signal fed into the second path via the feed;
the light processor being configured to:
detect dynamic changes along a span associated with the feed from the loop back signal.

In some embodiments, detecting dynamic changes along the span associated with the feed from the loop back signal includes detecting dynamic changes along the span associated with the feed from dynamic changes in the loop back signal.

In some embodiments, each node includes a feed from the forward path to the second path such that forward propagation from the forward path feeds the second path at each of the plurality of nodes to loop back a corresponding loop back signal, the response signal comprises the loop back signals corresponding to each of the feeds, and each span is associated with one or more of the feeds, the light processor being configured to:
for at least one span detect dynamic changes along the span from the loop back signal corresponding to one or more associated feeds.

In some embodiments, for each of the at least one span, detecting dynamic changes along the span from the loop back signal corresponding to one or more associated feeds includes detecting dynamic changes along the span from dynamic changes in the loop back signal corresponding to one or more associated feeds.

In some embodiments, the light processor is configured to perform dynamic environmental change detection for the or each of the at least one span from the detected dynamic changes along the respective span.

According to an aspect of the invention, there is provided an optical arrangement coupled into any of the systems recited above, comprising the light transmitter and a light detector, the light detector being coupleable into the light processor.

It will be appreciated that the systems recited above are configured to be used to perform the corresponding methods recited above and accordingly the systems can be configured to perform any of the preferred and/or optional steps of the corresponding methods.

The processing unit/light processor of any of the systems recited above can be configured to perform any of the steps of any of the methods recited above.

The system can be configured at a single location, or can be a distributed system with appropriate communication links.

According to an aspect of the invention, there is provided a method of using the HLLB for environmental detection.

Embodiments of the invention are described below, by way of example only, with reference to the accompanying drawings, in which:

### BRIEF DESCRIPTION OF THE DRAWINGS

FIG. 1 is a schematic diagram of a typical telecom optical link, as used in an embodiment of the invention.

FIG. 2 is a schematic diagram of loop back path feeds in the system of FIG. 1.

FIG. 3 is a schematic diagram of the system of FIG. 1.

FIG. 4 is a schematic diagram of part of the system of FIG. 1.

FIG. 5 is a plot illustrating part of the method of the system of FIG. 1.

FIG. 6 is a schematic diagram of a system according to an embodiment of the invention.

### DETAILED DESCRIPTION OF ILLUSTRATIVE EMBODIMENT(S)

As described in detail below, embodiments of the invention are able to perform dynamic environmental sensing and change detection with high spatial resolution using a forward propagation loop back path which is inbuilt into many optical fibre arrangements as a High Loss Loop Back path (HLLB). Conventionally, the High Loss Loop Back path is used to test the health of optical amplifiers. However, as described below, embodiments of the invention are able to exploit the loop back system to dynamically measure environmental changes along the fibre spans.

As described above, an existing technique to perform environmental sensing with high spatial resolution is called Distributed Acoustic Sensing (DAS). In this case the light reflected by inhomogeneities in the fibre is analysed. A pulse is sent and the information is extracted by analysing the returned signal at different times, corresponding to different distances along the fibre. Whilst this technique works well, because of the low level of the returned signal it is limited to the first tens of km. In contrast to this, embodiments of the present invention use a forward propagating signal returned at preconfigured loop back feeds rather than reflections in the fibre. This can provide a strong signal coming back, allowing effective monitoring over long distances.

In other known techniques, phase or polarization-based seismic detection techniques provide a signal that is integrated over the entire length of the submarine cable (5,000 to 7,000 km in the case of inter-continental links). In contrast to this, by using existing embedded High-Loss-Loop-Backs (HLLB) in embodiments of the invention, the cable can be “sliced” into sections, for example sections 50-80 km-long although they can be shorter or longer, effectively transforming the cable into a number of sensors, for example more than 100 sensors in some cases, rather than just 1.

In some embodiments of the invention, by sweeping the frequency of the transmitted light signal, signal elements relating to signals looped back from different repeaters can conveniently be distinguished based on frequency, allowing for a substantially continuous monitoring to be performed.

In some embodiments of the invention, differences can be taken between signals from the ends of a section, thereby allowing noise from other parts of the cable to be cancelled out so that a high sensitivity localised detection can be made. This also facilitates other detections to be made simultaneously for other sections of the cable.

An embodiment of the invention can be understood by reference to the accompanying figures.

FIG. 1 is a schematic diagram of a typical telecom optical link in the form of an optical fibre arrangement 10 between a first cable landing station 6 and a second cable landing station 8, forming a system of an embodiment of the invention. The optical link takes the form of one or more submarine cables.

The optical fibre arrangement 10 comprises two fibres (a fibre pair), the fibre pair being a first fibre 12 and a second fibre 14. Each fibre 12, 14 is used for one direction of propagation. The fibres 12, 14 are configured to be substantially parallel and adjacent, optionally attached, and contained within a common tube, usually filled with gel, such that environmental changes affect the first and second fibres in substantially the same manner.

Submarine cables typically have repeaters 16 because the optical fibre is lossy and the signal needs to be regenerated every 50-80 km. As can be seen in FIG. 1, each of the first and second fibres includes a plurality of repeaters 16 in this manner. In this embodiment, the repeaters 16 are optical amplifiers (no optical-to-electrical conversion). The optical fibre arrangement between each pair of adjacent repeaters 16 is referred to as a span 18. In other words, the optical fibre arrangement can be said to be configured into a plurality of spans 18 by a plurality of nodes, the plurality of nodes being between first and second ends of the optical fibre arrangement, there being a node at each end of each span. The nodes are provided in this embodiment by the repeaters 16. Each node is between adjacent spans. In this embodiment, the amplifiers are unidirectional.

The first fibre 12 can be said to provide a first optical path in a first direction and the second fibre 14 can be said to provide a second optical path in a second direction opposite to the first direction, although in other embodiments the fibre arrangement can include a single fibre providing both paths, for example if the amplifiers are bidirectional. In this discussion, the first path can be considered a forward path.

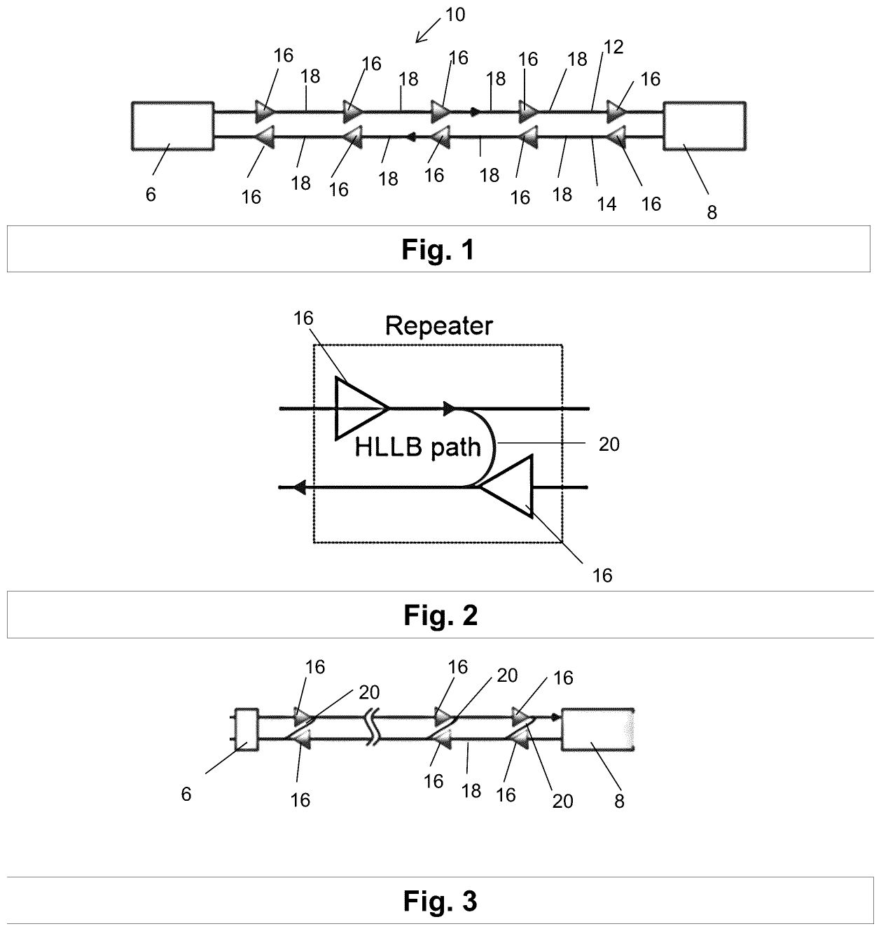

Modern repeaters such as the repeaters 16 in FIG. 1 have an embedded forward propagation loop back path feed 20 from the first path in the first fibre 12 to the second path in the second fibre 14 as can be seen more clearly in FIG. 2. A small fraction (usually 10% or less) of the optical power from an optical amplifier 16 is injected into the second path of the second fibre. In this way, the first path feeds the second path in forward propagation at each of the plurality of nodes, which is to say that each node is configured to transfer at least a portion of light travelling on the first path in the first direction to the second path in the second direction via the loop back path feed 20, forming a loop back signal in the second path.

This creates a lossy return path for the light. This is usually called High Loss Loop Back (HLLB). This loop is conventionally used to test the health of the optical amplifiers (by measuring the gain). Whilst the fibre can transmit a very wide range of wavelengths, these loop backs are usually wavelength-specific (by using optical filters).

As mentioned above, the second path is fed in forward propagation, meaning that the light signal travels unidirectionally with respect to the optical paths on its route through the first and second optical paths, in contrast to conventional DAS techniques described above which rely on reflections within the fibre.

As there will be a forward propagation loop back path feed 20 (HLLB) for each node (repeater 16) from each end the system provides a return path for the light of increasing length. Each return path comprises the respective loop back path feed and at least a portion of the second path and contributes a respective loop back signal to the second path. Together, the loop back signals form a response signal, which is received at a light processor at the first end of the fibre arrangement.

When received at the first end of the fibre arrangement, each loop back signal relates to dynamic changes to the optical fibre arrangement traversed by the light signal and the loop back signal up to and back from the respective node. This is because the optical path length to the respective node traversed by that portion of the light signal which forms the loop back signal, and then by the loop back signal on its return, will have been affected by any such dynamic changes.

Of course there exists a similar set of loop back path feeds from the second path to the first path for light travelling in the opposite direction transmitted from the second cable landing station 8, using the first path or portion thereof as the return path and in which the second path can be considered to be the forward path. Accordingly, all of this discussion can apply mutatis mutandis to light being transmitted into the second path at the second cable landing station 8 and returned to the second cable landing station 8 via the first path acting as a return path.

The first cable landing station 6 includes a light transmitter configured to transmit a light signal into the first end of the fibre arrangement into the first end of the first path. In this embodiment, the light transmitter includes a laser whose frequency can be swept directly or via an external device and the method uses Optical Frequency Domain Reflectometry (OFDR), although this is not necessary in every embodiment. Although the name of the OFDR technique refers to reflectometry as this is how it is usually used, it will be clear from this disclosure that the technique as being used in this embodiment does not actually use reflections.

In this embodiment, the light transmitter includes an external modulator configured to sweep the frequency of the light signal. However, in other embodiments, the laser itself can be configured to produce a swept frequency. In this embodiment, the laser is sufficiently stable so that changes measured over each span as a result of changes in the laser frequency are substantially smaller than the changes caused by the environmental perturbations to be measured, preferably at least 2 or 3 times smaller, that is to say 2 or 3 times smaller or even smaller.

Although in this embodiment the light transmitter includes a laser, in other embodiments, the light transmitter can be an optical fibre or other optical arrangement configured to convey light from a laser or other light source to the first end of the first path. In this embodiment, the frequencies swept are within the wavelength band of the loop back path feed 20.

It is to be noted that references to light in this disclosure can include any wavelengths that can propagate in the optical fibre arrangement. In this embodiment this includes infra-red light in the telecom wavelength band (1530-1560 nm), but other wavelength bands that can propagate in the optical fibre arrangement may additionally or alternatively be included.

The first cable landing station 6 also includes the light processor at the first end of the fibre arrangement at the end of the second path configured to receive and process the response signal from the second path.

In this embodiment, the first cable landing station 6 transmits a light signal using the light transmitter into the first end of the first path and thereby into the first path. The frequency of the light signal is swept at a predetermined rate by sweeping the frequency of the laser such that for each sweep the light signal has a continuously varying frequency. In this embodiment, the frequency of the light signal is swept with a saw-tooth like waveform resetting every 100 ms, with each sweep being between the resets. Accordingly, the frequency temporarily stops sweeping between sweeps in the time that it takes for the frequency to be reset to its initial value.

As the light signal passes along each span, its phase is affected by dynamic environmental changes to the span. This will result into a phase change of the returned signal to the first cable landing station 6.

At each node (repeater 16), a portion of the light signal propagating forward in the first path is fed into the second path via the respective loop back path feed 20, providing the loop back signal.

The loop back signals return to the first cable landing station 6 in the second path, combining to form the response signal.

As the loop back signals return in the second path, the phase will be affected by any dynamic environmental changes to the spans.

At the first cable landing station 6 the response signal is received and processed by the light processor. In this embodiment, the light processor includes a light detector in the form of a photodetector and processing the response signal includes detecting a response beat signal, formed from optically combining the response signal and a reference signal on the photodetector, the reference signal being the light signal in this embodiment, and converting the response beat signal to an electrical signal. However, in other embodiments, the light detector can detect the response signal without forming a beat signal.

Although this embodiment uses a light detector to produce an electrical signal, in other embodiments the light processor can process the response signal in the optical domain.

Because the nodes are each at different distances from the first cable landing station 6, each loop back signal arrives at the light processor with a different frequency difference as compared to the reference signal. Accordingly, the response beat signal includes a plurality of loop back beat signals at different frequencies, each loop back beat signal corresponding to a node and a loop back signal and being formed from optically combining the corresponding loop back signal and the light signal on the photodetector. The frequency of each loop back beat signal is the difference between the frequency of the corresponding loop back signal received and the frequency of the light signal concurrently transmitted.

It is to be noted that in this embodiment, the loop back beat signals are formed from the loop back signal received at the light processor and the light signal concurrently transmitted.

The light processor is communicatively linked to the light transmitter and is configured to perform the signal processing and change detection and monitoring described below. In this embodiment, this processing is performed electronically after detection of the response beat signal, but as mentioned above in other embodiments some or all of it can be performed in the optical domain. The light processor may include memory to store signals as they await processing and optionally to store results. It can include an output to provide output to a user in any form. There can be a similar light processor at the second cable landing station 8 for operating the second optical path as the forward path.

Although the light processor is described as being at the first cable landing station 6 or the second cable landing station 8, it does not need to be entirely at the cable landing station; parts can be remote from the cable landing station and can be distributed over several locations, provided that there are appropriate communicative links to allow the passing of data. For example, if the light processor includes a light detector to produce an electrical signal, the electrical signal can be converted to a data signal which can be relayed to different locations for further processing.

The loop back beat signals are distinguished and separated from the response beat signal based on the frequencies of the loop back beat signals. In other words, because each of the loop back beat signals is at a different frequency, they can be distinguished from each other and each matched with a corresponding loop back feed.

To put it another way, signal elements, in this embodiment the loop back beat signals, relating to each of the loop back signals, are obtained from the response signal. As described below, these allow detections to be made that are ultimately derived from dynamic changes in the individual loop back signals.

Each span is associated with the adjacent loop back feed(s) and node(s). Accordingly, most spans have two associated loop back feeds and nodes, a first associated feed at a far end of the span with respect to the light transmitter, and a second associated feed at a near end of the span with respect to the light transmitter.

For each span 18, dynamic changes along the span are detected from dynamic changes in the loop back signal or signals from one or more of the associated loop back feeds.

In this embodiment, dynamic changes along the span are detected from dynamic changes in the loop back beat signal corresponding to the first associated feed, in particular in phase changes thereof. Dynamic changes are detected from any phase change of the returned light with respect to the injected light. However, as discussed below, in this embodiment the loop back beat signal reveals dynamic changes along the fibre arrangement up to the first associated feed so for the majority of spans further processing is performed to isolate the dynamic changes specifically along the span.

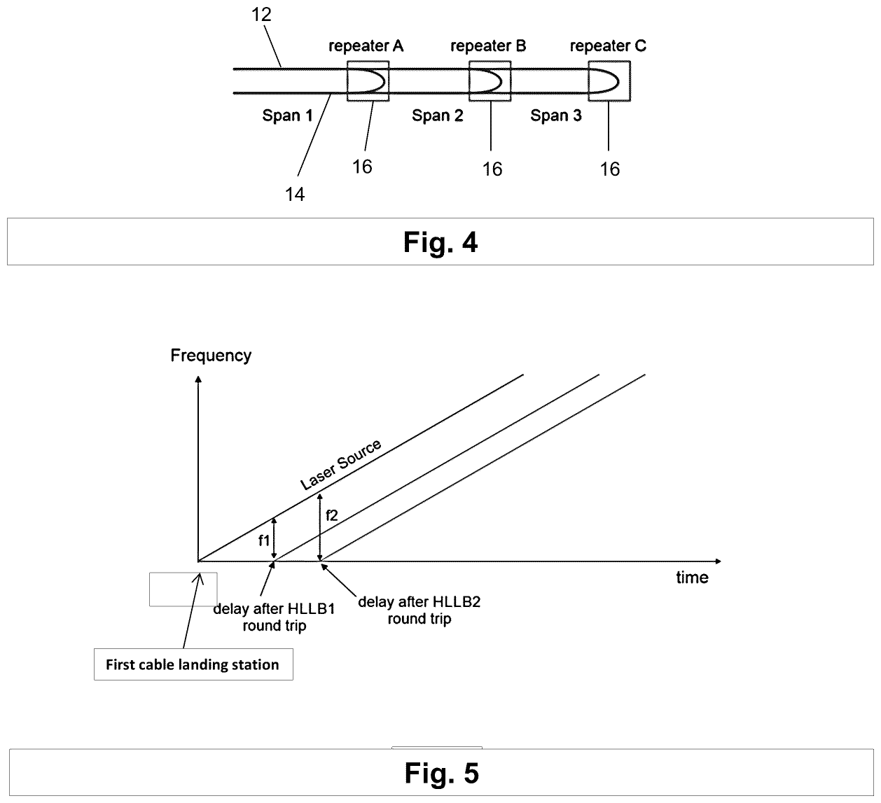

For example, FIG. 5 shows the frequency with respect to time for three signals. The frequency of the light signal transmitted by the light transmitter of the first cable landing station, sweeps. The returned sweep in the loop back signal from a first node (HLLB1) as received at the light processor is shown in red, and in the loop back signal from a second node (HLLB2) as received at the light processor is shown in green. The time-axis distance from the transmitted light signal sweep to the respective received loop back signal sweeps shows the round-trip delays to the respective nodes. As can be seen, each received loop back signal has a generally consistent frequency difference (f1, f2 respectively) from the light signal being concurrently transmitted. The loop back beat signals have frequencies corresponding to these frequency differences. Changes in the phase of these loop back beat signals indicate changes in light propagation in the fibre arrangement between the light transmitter and the respective node and back.

Changes derive from a change in propagation time. But:

Changes arising from Doppler are first order and are what are primarily measured.

Second order changes arise from fluctuations in the time at which the two sweeping slopes are sampled.

The loop back beat signal constitutes of two parts, an offset and a dynamic part. 1 above relates to the dynamic part (phase changes to changes in the propagation time), 2 above relates to the modulation of the offset due to changes in the propagation time. This one is smaller than the direct change.

Accordingly, the dynamic changes in the loop back beat signals relate to any phase change in the loop back beat signals.

As discussed, dynamic changes in a loop back beat signal do not only reveal dynamic changes along a span, but reveal integrated dynamic changes along the whole fibre arrangement from the first cable landing station 6 to the associated loop back feed. However, where appropriate these can be differentiated from the integrated dynamic changes determined for the adjacent loop back feed closer to the first end of the fibre arrangement to isolate the dynamic changes along the span.

In this embodiment, for spans which have nodes at both ends, dynamic changes along the span are detected from dynamic changes in a difference between the loop back beat signal corresponding to the first associated feed and the loop back beat signal corresponding to the second associated feed. In this embodiment dynamic changes along the span are detected from dynamic changes in the phase, although in other embodiments it can additionally or alternatively be from dynamic changes in the frequency, of the said difference. In other words, dynamic changes along the span are detected from dynamic changes in a difference signal, the difference signal being the loop back beat signal corresponding to the second associated feed subtracted from the loop back beat signal corresponding to the first associated feed (it will be appreciated by the skilled person that the difference in this context is a frequency difference, in other words the subtraction is a subtraction of the frequency of one from the frequency of the other). Taking this difference has particular advantages in that it can significantly increase the sensitivity of the method. In particular, by taking the difference between the loop back beat signal corresponding to the first associated feed and the loop back beat signal corresponding to the second associated feed, the method can substantially remove the noise that has accumulated in the loop back signals owing to the light signal and loop back signals passing through other spans in the optical fibre that are closer to the transmitter. The noise will be suppressed by taking the difference. This substantially increases the sensitivity of the system to dynamic changes along the span in question.

As mentioned, in this embodiment, dynamic changes along the span are detected from dynamic changes in the phase of the difference signal.

In other embodiments, dynamic changes along the fibre arrangement up to the first associated feed are detected from dynamic changes in the loop back beat signal corresponding to the first associated feed, dynamic changes along the fibre arrangement up to the second associated feed are detected from dynamic changes in the loop back beat signal corresponding to the second associated feed, and dynamic changes along the span are detected by subtracting the dynamic changes along the fibre arrangement up to the second associated feed from the dynamic changes along the fibre arrangement up to the first associated feed.

In some other embodiments, the light detector can detect the response signal directly. In such embodiments, signal elements in the form of the loop back signals themselves can be distinguished and separated from the response signal based on the frequencies of the loop back signals, noting that these frequencies will be changing over time as a result of the light signal having been swept. The loop back signals can then be compared to each other or to the light signal to detect dynamic changes along the spans from dynamic changes in the phase (or other internal feature) of the loop back signals. This can be done for example by detecting dynamic changes along a span from dynamic changes in a difference between the loop back signal corresponding to a first associated feed and the loop back signal corresponding to a second associated feed, in a manner corresponding to that discussed above for loop back beat signals, although in this case the signals are not beat signals as they have been detected directly.

The dynamic changes along the span are analysed to detect dynamic environmental changes along the span 18. As can be appreciated, dynamic changes to light propagation through the entire length of the span are detected and therefore dynamic environmental changes along the entire length of the span are detected.

With reference to FIG. 4, by subtracting the signal from two consecutive nodes (repeaters 16), the environmentally induced signal sensed by each span 18 between repeaters 16 can be isolated:
Span 1=Repeater A
Span 2=Repeater B−Repeater A
Span 3=Repeater C−Repeater B

This means that rather than having a single output signal for the whole length of fibre, the cable is “split” into as many sections as the number of spans.

Note that each loop signal, otherwise referred to as a loop back beat signal, also carries information about the environmental noise from land to that point. If, for example, one has a 300 km link consisting of three 100 km spans, one will have
A=land
B=repeater at 100 km
C=repeater at 200 km
D=repeater at 300 km
Environmental change on A-B Span computed as (A to B loop data)
Environmental change on B-C Span computed as (A to C loop data)−(A to B loop data)
Environmental change on C-D Span computed as (A to D loop data)−(A to C loop data)

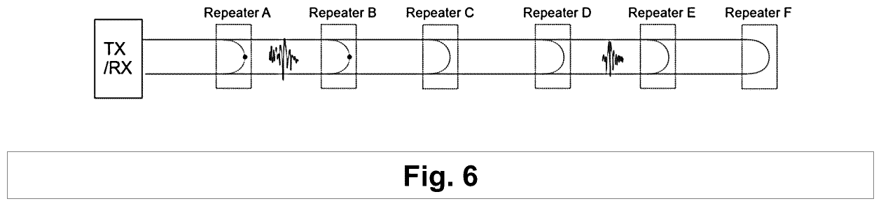

This embodiment is therefore able to provide a lower detection threshold (and therefore higher sensitivity) as compared to embodiments which do not take a difference between the signals returned from nodes at each end of a span, for example as follows. FIG. 6 shows an embodiment configured as per the embodiment of FIG. 1. Two loop back signals were obtained from the following optical paths:
S1: TX-B-TX
S2: TX-A-TX
S3: TX-D-TX
S4: TX-E-TX

Where S1, S2, S3 and S4 are the measured dynamic phase changes on the indicated paths.

If one performs the S4−S3 difference, one gets the environmentally induced perturbation detected only in the D-E span. This localizes the perturbation along the cable to 1 span length accuracy, but also has another very important consequence. The measurement noise floor (the detection threshold in the case of earthquakes), depends only on the background noise accumulated in the D-E span. The noise accumulated between TX and D drops out as it is common to both loop-backs (so is suppressed when computing the difference). If other perturbations are simultaneously present on the optical path TX-D (for example on the span A-B in FIG. 6), these will not contribute to the optical phase changes detected on the D-E span.

In addition, as shown, simultaneous events on different spans can be detected (the black wiggles).

Of course, two or more adjacent spans can be treated as a single span in order to detect integrated dynamic changes over a longer section of the fibre arrangement, in which case the intermediate nodes can be ignored. In addition, the method and system can be used to detect and monitor dynamic changes along a single specific span while ignoring changes occurring over the rest of the fibre arrangement, for example if one span crosses an area of high seismic activity.

As described, in this embodiment, the property of the loop back beat signals that is of interest is the phase. This is because dynamic environmental changes such as vibrations, temperature, humidity and pressure perturbations affect the optical path length through the span and therefore cause the phase of the detected signal to change.

Accordingly, detecting dynamic changes along each span can result in detection of vibrations, temperature, pressure, and humidity perturbations at each span, which can be used to detect dynamic environmental changes along the span. In this embodiment, the system and method are configured to utilise this detection to provide seismic detection, in particular detection of earthquakes, although other environmental phenomena, such as wave and currents-induced changes, can also/alternatively be detected and/or monitored.

This method can substantially improve seismic detection capabilities of non-reflection-based fibre sensing techniques for seismic detection and environmental monitoring in general. It can provide advantages including a substantially lower seismic detection threshold, intrinsic localization, in some examples to 50-80 km although this can be shorter or longer, and an ability to resolve direction of the seismic wave and spatial evolution over time. Among other applications, it could be used for geophysics, early tsunami detection, climate change monitoring.

As described above, this method and system can exploit components already present in many optical fibre arrangements to provide spatial resolution while maintaining a strong signal which can be utilised along the length of long submarine cables, and this can be done without requiring additional components to be retrofitted along the submarine cable.

In some embodiments, the same procedure can also be performed, preferably at the same time, in the opposite direction, in other words with a light transmitter and light processor at the second cable landing station 8, and using the second optical path as the forward path and the first optical path for returning the node and response signals to the second cable landing station 8. Performing the procedure from both cable landing stations can allow the results to be combined for better environmental detection.

Correlation techniques can be used to improve spatial resolution. For example by running the presented technique from both ends of the fibre arrangement and correlating the resulting signals, the position of the perturbation along the fibre can be identified to much greater accuracy than the span length.

In some embodiments, there can be multiple instances of the light signal, resulting in multiple instances of the loop back signal(s). It is to be noted that dynamic changes in the or each loop back signal can include dynamic changes between different instances of the or each loop back signal, for example resulting from different instances of the light signal, and/or can include dynamic changes occurring within a single instance of the or each loop back signal.

Although in the embodiments described above the signal elements (for example the loop back signals or the loop back beat signals) are distinguished based on their frequency as a result of the light signal being swept, in other embodiments the light signal does not need to be swept and signal elements can be distinguished in other ways. For example, the light signal can be pulsed, for example by pulsing the laser, or the light signal can be modulated (switched on and off), for example by modulating the laser with an external modulator, and in either case the signal elements can be obtained from the response signal based on the time of receipt of the corresponding loop back signals at the light processor at the end of the second path.

Although the embodiments described above use Optical Frequency Domain Reflectometry (OFDR), other methods can be used in other embodiments. For example, in one embodiment, the light signal is pulsed, for example by pulsing the laser, and the loop back signals are distinguished from the response signal based on the time of receipt of the loop back signals at the light processor at the end of the second path, and, for each span, dynamic changes along the span are detected from dynamic changes in polarisation of the loop back signals. This is because dynamic environmental changes along the span can affect the polarisation change to light passing through the span.

It is also possible to detect dynamic changes along each span from dynamic changes in the loop back signal from one or more associated loop back feeds, where the dynamic changes relate to dynamic changes in the elapsed time between transmission and receipt at the light processor at the end of the second path. For example, in one such embodiment, the loop back signals are distinguished from the response signal based on the time of receipt of the loop back signals at the light processor at the end of the second path, and the difference in the time of receipt at the light processor of the loop back signals from nodes at each end of a span is identified and monitored. By monitoring this difference for multiple instances of the light signal, it can be determined if the difference is changing so as to indicate a dynamic environmental change at the span.

Of course, modifications applicable to embodiments using OFDR can be applied to the other embodiments, for example treating multiple adjacent spans as a single span, and not detecting and monitoring changes along every span.

In general, dynamic changes along a span are preferably detected from dynamic changes to an internal feature of the relevant loop back signal(s) as this can provide rapid results, facilitating the detection of dynamic events. An internal feature is a feature that could theoretically be measured at any point, rather than relating to the journey of the signal. Examples of internal features include frequency and polarisation, as described above. Other examples include intensity, wavelength and phase. Any internal feature that is affected by changes along the span can be measured.

It is not excluded that features of different embodiments can be combined, for example the frequency of the light signal can be swept in the manner discussed above to allow distinguishing the signal elements/loop back signals based on frequency to allow a longer measurement time, but an identification of polarisation difference can be used as discussed above, instead of or in addition to a detection of phase changes, to detect dynamic changes along the spans.

It is also not excluded that the spans and/or nodes can include sensors configured to detect conditions such as dynamic changes and add information relating to such detections into the loop back signals.

Whilst the embodiments above relate primarily to seismic detection, the method can be applied in many other uses, for example to measure the maximum temperature variation of each span for global warming monitoring. Ultimately, anything that changes the properties of the fibre at the span so as to affect the propagation of light therethrough can be detected.

Although the above embodiments are described with reference to a submarine cable, it will be appreciated that this disclosure can be applied to an optical fibre arrangement irrespective of whether it passes under the sea, for example it can apply to a terrestrial cable which is entirely on land, or to an optical fibre arrangement which has a significant extent on land and a significant extent under the sea.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

What is claimed is:

1. A method of dynamic change detection using an optical fibre arrangement, the optical fibre arrangement comprising a forward optical path and a second optical path, the optical fibre arrangement being configured into a plurality of spans by a plurality of nodes, the plurality of nodes being between first and second ends of the optical fibre arrangement, a first span having a first node at a first end and a second node at a second end, each of the first and second nodes including a feed from the forward optical path to the second optical path such that forward propagation of a light signal from the forward optical path feeds the second optical path, the method comprising:
transmitting said light signal into the forward optical path;
receiving a response signal from the second optical path, wherein the response signal comprises a first loop back signal and a second loop back signal, the first loop back signal comprising said light signal fed into the second optical path via the feed of the first node, the second loop back signal comprising said light signal fed into the second optical path via the feed of the second node;
obtaining from the response signal a first signal element and a second signal element relating to, respectively, the first loop back signal and the second loop back signal; and
detecting dynamic changes along the first span from dynamic changes in a difference between the first signal element and the second signal element.

2. The method of claim 1, wherein dynamic changes along the first span are detected from phase changes and/or frequency changes in the first signal element and/or the second signal element.

3. The method of claim 1, wherein the frequency of the light signal is swept such that the light signal includes at least one frequency sweep, wherein optionally the first signal element and the second signal element are obtained based on frequency of the first loop back signal and the second loop back signal.

4. The method of claim 3, wherein each of the at least one frequency sweep has a continuously varying frequency.

5. The method of claim 1, wherein the first signal element and the second signal element are the first and second loop back signals respectively.

6. The method of claim 1, wherein the first signal element is a first loop back beat signal formed from the first loop back signal and a reference signal; and
wherein the second signal element is a second loop back beat signal formed from the second loop back signal and the reference signal.

7. The method of claim 6, wherein the reference signal includes the light signal.

8. The method of claim 1, further comprising detecting vibrations, temperature, humidity and pressure perturbations along the first span.

9. The method of claim 1 further comprising performing dynamic environmental change detection for the first span from the detected dynamic changes.

10. The method of claim 1, further comprising performing seismic detection, for example detection of earthquakes.

11. The method of claim 1, wherein, detecting dynamic changes along the first span comprises using Optical Frequency Domain Reflectometry (OFDR).

12. The method of claim 1, wherein a plurality of spans are each configured as recited for the first span and result in the response signal comprising respective loop back signals for each span as recited for the first span, the steps for detecting dynamic changes along the respective span from the respective loop back signals being as recited for the first span.

13. A system for detecting dynamic change, comprising:
a light transmitter configured to transmit a light signal into a forward path of an optical fibre arrangement, the optical fibre arrangement comprising a second path and being configured into a plurality of spans by a plurality of nodes, the plurality of nodes being between first and second ends of the optical fibre arrangement, a first span having a first node at a first end and a second node at a second end, each of the first and second nodes comprising a feed from the forward path to the second path configured to feed forward propagation of the light signal from the forward path into the second path; and
a light processor configured to process a response signal received from the second path, the response signal comprising a first loop back signal and a second loop back signal, the first loop back signal comprising said light signal fed into the second path via the feed of the first node, the second loop back signal comprising said light signal fed into the second path via the feed of the second node,
the light processor being configured to:
obtain from the response signal a first signal element and a second signal element relating to, respectively, the first loop back signal and the second loop back signal; and
detect dynamic changes along the first span from dynamic changes in a difference between the first signal element and the second signal element.

14. The system of claim 13, wherein the light transmitter is configured to sweep the frequency of the light signal such that the light signal comprises at least one frequency sweep.

15. The system of claim 13 wherein the light processor is configured to perform dynamic environmental change detection for the first span from the detected dynamic changes along the first span.

16. The system of claim 13, wherein a plurality of the spans are each configured as recited for the first span and result in the response signal comprising respective loop back signals for each span as recited for the first span, the light processor being configured to perform the steps for detecting dynamic changes along the respective span from the respective loop back signals, as recited for the first span.

17. An optical arrangement coupled into a system for detecting dynamic change, the system comprising:
a light transmitter configured to transmit a light signal into a forward path of an optical fibre arrangement, the optical fibre arrangement comprising a second path and being configured into a plurality of spans by a plurality of nodes, the plurality of nodes being between first and second ends of the optical fibre arrangement, a first span having a first node at a first end and a second node at a second end, each of the first and second nodes comprising a feed from the forward path to the second path configured to feed forward propagation of the light signal from the forward path into the second path; and
a light processor configured to process a response signal received from the second path, the response signal comprising a first loop back signal and a second loop back signal, the first loop back signal comprising said light signal fed into the second path via the feed of the first node, the second loop back signal comprising said light signal fed into the second path via the feed of the second node,
the light processor being configured to:
obtain from the response signal a first signal element and a second signal element relating to, respectively, the first loop back signal and the second loop back signal; and
detect dynamic changes along the first span from dynamic changes in a difference between the first signal element and the second signal element;
the optical arrangement comprising the light transmitter and a light detector, the light detector being coupleable into the light processor.
